(19) United States
(12) Patent Application Publication
(10) Pub. No.: US 2005/0134021 A1
(43) Pub. Date: Jun. 23, 2005

(54) Gas bag module

(75) Inventors: Dominique Acker, Gschwend (DE); Sven Hofmann, Schwaebisch Gmuend (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive GmbH

(21) Appl. No.: 11/011,002

(22) Filed: Dec. 13, 2004

(30) Foreign Application Priority Data
Dec. 22, 2003 (DE) 103 60 468.5

(51) Int. Cl. B60R 21/20

(52) U.S. Cl. 280/728.2; 280/729

(57) ABSTRACT

A gas bag module (10) for a safety arrangement in vehicles comprises a gas bag (12) which has at least two chambers (16, 18) separated from each other by a separating seam (20) and has a mounting opening (22) formed in one of the chambers (18), and a gas generator (14) held at least partially in the mounting opening (22). The gas generator comprises a housing (24) which has a diffusor section (26) associated with the chambers (16, 18) and has a fastening section (30, 32) for mounting the gas generator (14) securely with the vehicle. The fastening section (28) of the gas generator housing held in the mounting opening (22) adjoins a wall section (42) of the mounting opening (22) on the inside thereof. Further, a fastening means (44) is provided, which fixes the wall section (42) to the fastening section (30, 32) from the exterior and also acts upon the separating seam (20) with tension and secures it to the diffusor section (26).

### FIELD OF THE INVENTION

The invention relates to a gas bag module for a safety arrangement in vehicles, comprising a gas bag having at least two chambers separated from each other by a separating seam and a mounting opening formed in one of the chambers, and comprising a gas generator mounted at least partially in the mounting opening and having a housing which comprises a diffusor section associated with the chambers and a fastening section for installing the gas generator securely with the vehicle.

### BACKGROUND OF THE INVENTION

A gas bag module disclosed in DE 298 22 159 U1 concerns in particular a gas bag side impact protection arrangement, which protects a vehicle occupant in a side impact from contact with the side structure of a vehicle or with penetrating vehicle parts. The known protection arrangement comprises a two-chambered gas bag, the first chamber of which extends in the inflated state to the side of the chest of a vehicle occupant and the second chamber of which in the inflated state protects the pelvic region of the vehicle occupant. The chambers can be filled so that in the filled state they have different internal pressures. For this purpose, the chambers are separated from each other by a separating seam which must lie closely against the housing of the gas generator which is introduced into the gas bag, in order to avoid an undesired pressure equalization. The dimensions of the gas generator housing and of the gas bag must therefore be coordinated very precisely with each other. Owing to the small tolerances of these dimensions, the installation of the gas generator involves considerable manufacturing expenditure. This manufacturing expenditure is further increased in that the fastening tongues present on the gas generator housing must be inserted in succession through openings in the gas bag wall.

### SUMMARY OF THE INVENTION

By comparison, the invention provides a gas bag module which is able to be installed simply, with a secure sealing of the chambers with respect to the gas generator housing.

According to the invention, a gas bag module is provided for a safety arrangement in vehicles, comprising a gas bag, which has at least two chambers separated from each other by a separating seam, and has a mounting opening formed in one of the chambers, and comprising a gas generator, mounted at least partially in the mounting opening and having a housing which comprises a diffusor section associated with the chambers and a fastening section for mounting the gas generator securely with the vehicle, and which is characterized in that the fastening section, mounted inside the mounting opening, adjoins a wall section of the mounting opening and that further a fastening means is provided which fixes the wall section from the exterior of the mounting opening on the fastening section and acts upon the separating seam with tension and secures it on the diffusor section.

Owing to the invention, it is possible to construct the mounting opening larger than in the prior art and during the installation to also increase the distance of the separating seam, which separates the two gas bag chambers from each other, to the gas generator housing. Therefore, the gas generator with its housing can be pushed more easily into the mounting opening. In addition, the necessity for having to guide the fastening tongues on the gas generator through openings provided in the gas bag wall is eliminated, because the fastening section remains inside the gas bag. Through the greater structural space available, the mounting of the gas bag module can also be automated. Nevertheless, the invention ensures a secure sealing of the separating seam on the gas generator housing, so that no gas can overflow from one chamber into the other chamber. Therefore, on the one hand high internal pressures can be achieved and, on the other hand, higher pressure differences.

Finally, the invention permits a more flexible mounting of the gas generator in the gas bag, because the mounting opening in the gas bag can be fixed at any desired site of the gas generator housing. Therefore, for example, it is possible to keep the connector side of the gas generator freely accessible from the exterior, whereby also the further installation processes at the vehicle manufacturer is facilitated.

According to a preferred embodiment of the invention, the gas generator is a tubular gas generator and the gas bag is a two-chambered side gas bag. Advantageously, the diffusor section of the gas generator housing is adapted for filling the chambers with a different pressure distribution. This can be achieved for example in that—as described in DE 298 22 159 U1—the gas passage openings associated with the respective chambers have a different free overall cross-section. As an alternative to this, different quantities of gas can also be supplied to the respective diffusor sections, for example with the use of a multiple-stage gas generator. In this way, a restraint effect can be achieved which is optimally adapted to the different areas of the vehicle occupant's body. The gas generator housing with the diffusor section and the fastening section can be an integral component part of the gas generator. However, a part which is separate from the gas generator, which is securely connected with the gas generator and thus forms a structural unit therewith, is preferred.

In a particularly preferred embodiment, the fastening section of the gas generator housing lies opposite the diffusor section and is constructed as a flat, radially projecting fastening tongue running along the housing.

Preferably the fastening tongue is formed in one piece with the gas generator housing. It can be formed continuously or divided into several sections lying in the same plane.

The fastening means, which fixes the wall section of the mounting opening from the exterior on the fastening section, is formed from two opposite strips in a simple embodiment. Thereby, a particularly simple installation, able to be automated, of the gas bag is possible. For this, the strips are applied from the exterior onto the fastening section on the gas generator housing and thereby clamp between them the wall section adjoining the fastening section and the fastening sections. Through this process, the slack present at the mounting opening or in the region of the separating seam is eliminated and the separating seam is drawn in the direction of the gas generator housing or the diffusor section. Thereby, a reliable sealing of the gas bag chambers with respect to each other is ensured. The fastening of the gas bag module can take place by means of fastening points provided on the strips, which correspond to fastening points on the fastening tongue.

Instead of two separate strips, the fastening means can also be one strip with a U-shaped cross-sectional profile, which preferably has a perforated fold. To install the gas bag module, the U-shaped profile strip is placed with its free arms onto the fastening tongue on the gas generator housing, so that the wall section of the mounting opening adjoining the fastening tongue is clamped between the arms. For easier installation, the profile strip can also be bent up onto the fastening tongue. This process is substantially facilitated by the perforation in the fold. Also in this embodiment, the fastening to the vehicle can take place by means of fastening points provided on the strip, which correspond to fastening points on the fastening tongue of the gas generator housing.

### BRIEF DESCRIPTION OF THE DRAWINGS

Further features and advantages of the present invention will be apparent from the following description of a preferred embodiment in connection with the drawings, to which reference is made. In the drawings:

FIG. 1 shows a perspective view of the gas bag module according to the invention, in non-activated state;

FIG. 2 shows a side view of the gas bag of the gas bag module according to the invention, in unfolded state;

FIG. 3 shows a side view of the gas distributor housing of the gas bag module according to the invention;

FIG. 4 shows a second side view of the gas distributor housing;

FIG. 5 shows a third side view of the gas distributor housing;

FIG. 6 shows a sectional view of the gas distributor housing along the line I-I in FIG. 3;

FIG. 7 shows a sectional view of the gas distributor housing along the line II-II in FIG. 3;

FIG. 8 shows a sectional view of the gas distributor housing along the line III-III in FIG. 4;

FIG. 9 shows a diagrammatic sectional view of the gas bag module according to the invention before the installation of the fastening strip;

FIG. 10 shows a diagrammatic sectional view of the gas bag module after the installation of the fastening strip;

FIG. 11 shows a side view of the fastening strip of the gas bag module according to the invention;

FIG. 12 shows a second side view of the fastening strip;

FIG. 13 shows a third side view of the fastening strip; and

FIG. 14 shows a sectional view of the fastening strip along the line IV-IV in FIG. 11.

### DETAILED DESCRIPTION OF A PREFERRED EMBODIMENT

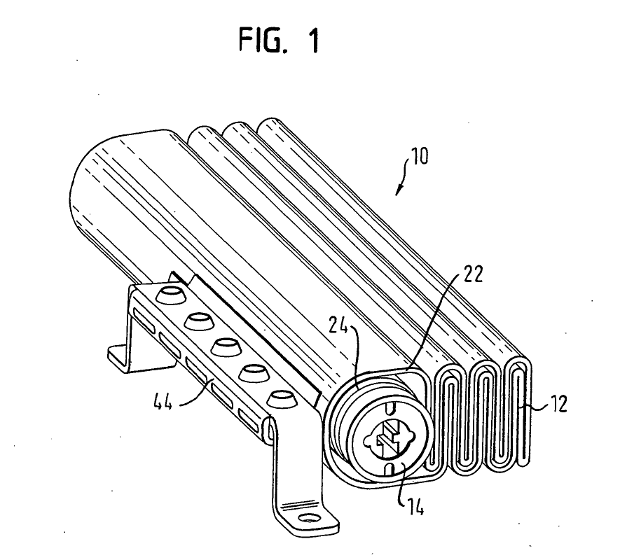

The gas bag module 10 shown in non-activated state in FIG. 1 has an inflatable gas bag 12 and a gas generator 14. The gas generator 14 has a housing which is constructed here as a separate gas distributor housing 24 and is securely connected with the gas generator 14. The gas distributor housing 24 and the gas generator 14 incorporated therein are mounted together in a mounting opening 22 of the gas bag 12. By means of a strip 44 installed on the back rest of a vehicle seat (not illustrated) so as to be secure with the vehicle, the gas bag 12 is connected securely with the gas generator 14 and the gas distributor housing 24.

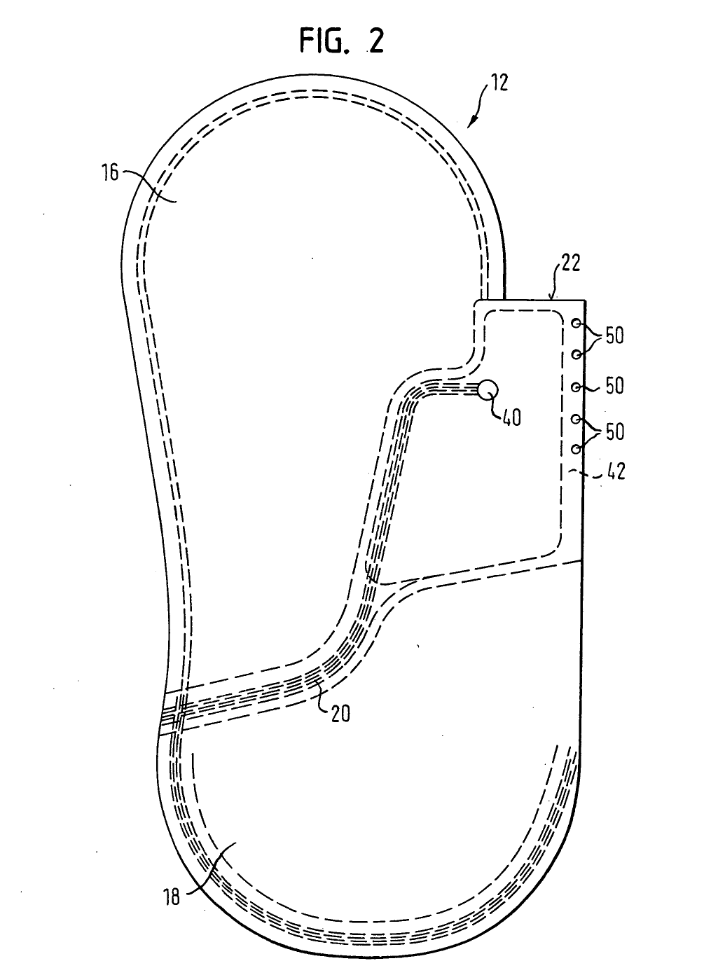

The gas bag 12 shown in FIG. 2 in the unfolded state has a first chamber 16 and a second chamber 18. The upper, first chamber 16 can be inflated to the side of the chest of a vehicle occupant. The lower, second chamber 18 extends to the side of the pelvic area of the occupant. The chambers 16, 18 are completely separated from each other here by a separating seam 20. At the free right-hand end of the separating seam, in addition a reinforcement 40 is provided, which prevents a tearing of the separating seam 20 during the inflation process. The two chambers 16, 18 have a different internal pressure in the inflated state of the gas bag 12. In particular, the internal pressure in the first chamber 16 is higher than in the second chamber 18, the pressure difference being able to amount to more than 1 bar.

A pocket is arranged on the first chamber 16 of the gas bag 12 and forms the mounting opening 22 for receiving the gas distributor housing 24 or the gas generator 14, respectively. The gas generator 14 is securely connected with the pocket. The wall of the pocket has, in addition, a wall section 42 which lies opposite the separating seam 20 or the reinforcement 40 and is provided with holes 50 which make possible a secure connection of the gas bag 12 with the gas generator 14 or the gas distributor housing 24.

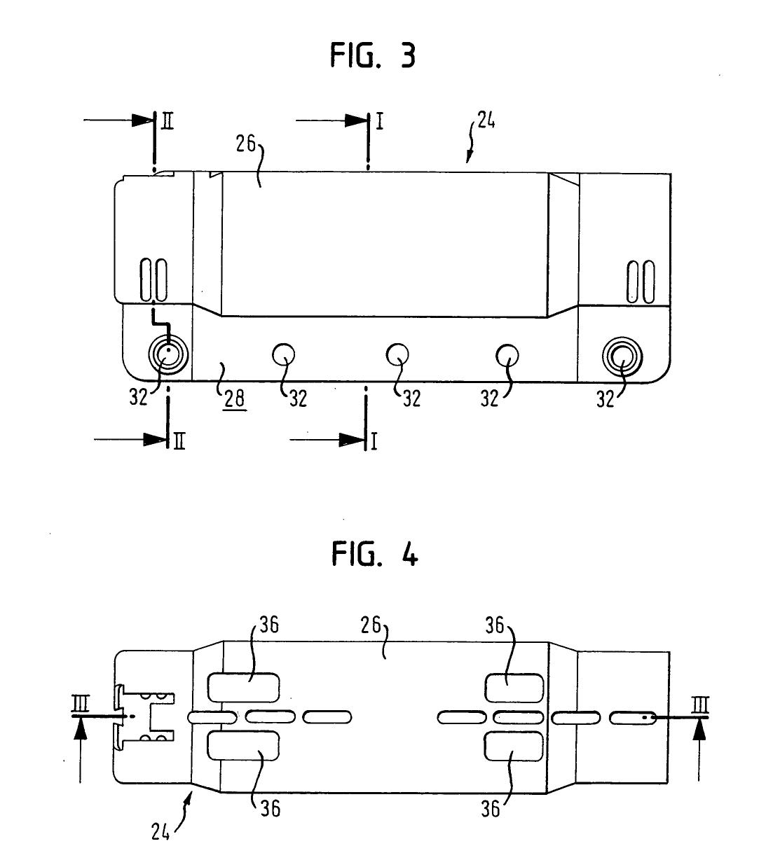

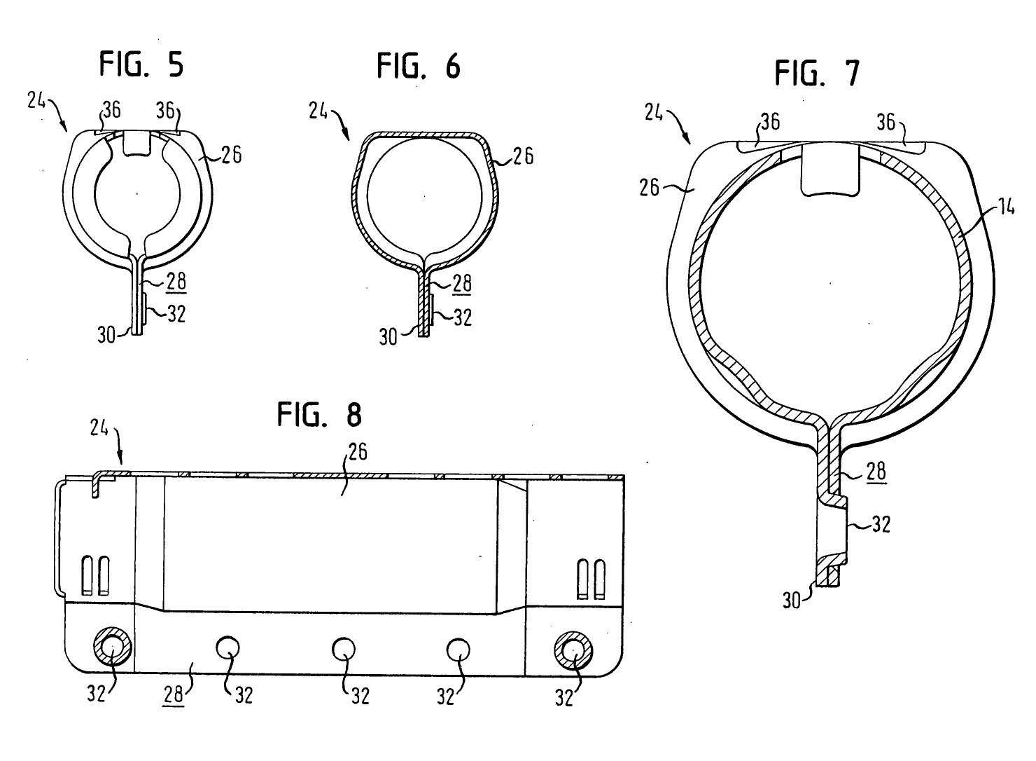

The gas distributor housing 24 illustrated in FIGS. 3 to 8 comprises a flattened diffusor section 26 and a fastening section 28 lying opposite the diffusor section 26. The diffusor section 26 of the gas distributor housing 24 has gas passage openings 36, via which the gas flowing out from outlet openings, not illustrated, on the gas generator 14 is supplied to the chambers 16, 18 in the gas bag 12. The gas passage openings associated with the respective chambers 16, 18 can have a different free overall cross-section, in order to ensure a different filling of the chambers 16, 18 and to produce a pressure difference. For this, the separating seam 20 with its reinforcement 40 lies in the operating state of the gas bag module 10 closely against the flattened diffusor section 26 of the gas distributor housing 24, whereby a passage of gas from the chamber 18 over into the chamber 16 or vice versa is prevented. The reinforcement 40 arranged at the end of the separating seam 20 lying against the diffusor section 26 also prevents a tearing of the separating seam 20 during the inflation process or during the impact of a vehicle occupant onto the gas bag 12. At its free ends, the gas distributor housing 24 is narrowed (FIG. 5) and surrounds the gas generator 14 (not shown) in the manner of a tube clip, so that the gas generator 14 is held securely in the gas distributor housing 24. On the other hand, the internal diameter of the gas distributor housing is greater in its central section than the external diameter of the gas generator 14. This means that the inner wall of the gas distributor housing is spaced apart from the gas generator 14, so that a free flow space results for the gas emerging from the gas generator 14 (FIGS. 2 and 3).

The fastening section 28 is formed from two plates 30 lying against each other, which together form a flat fastening tongue 30 projecting radially from the gas distributor housing 24 and extending along the housing. In the fastening tongue 30, fastening points 32 are provided, the function of which is explained further below.

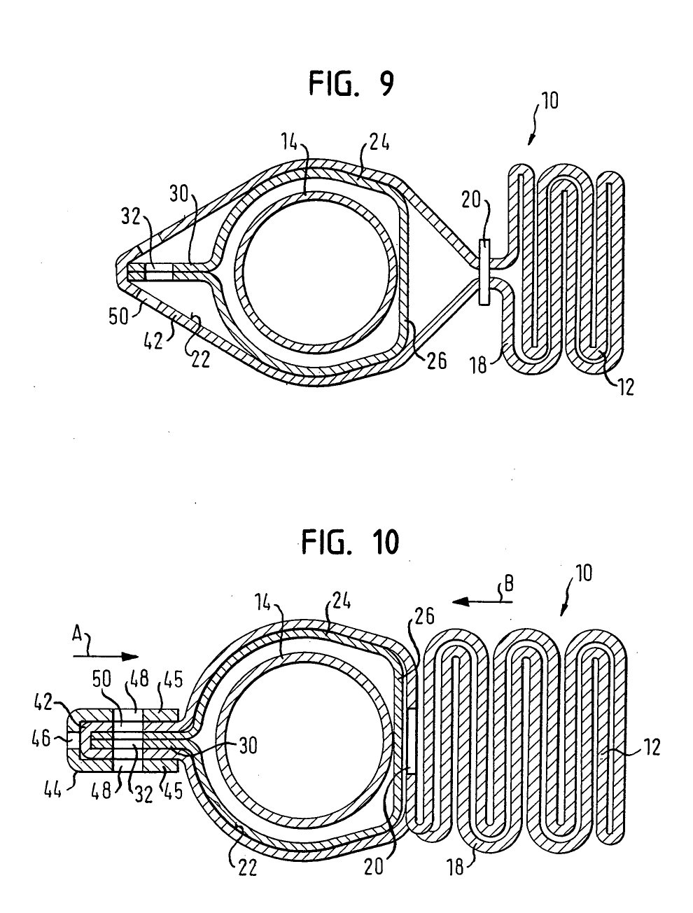

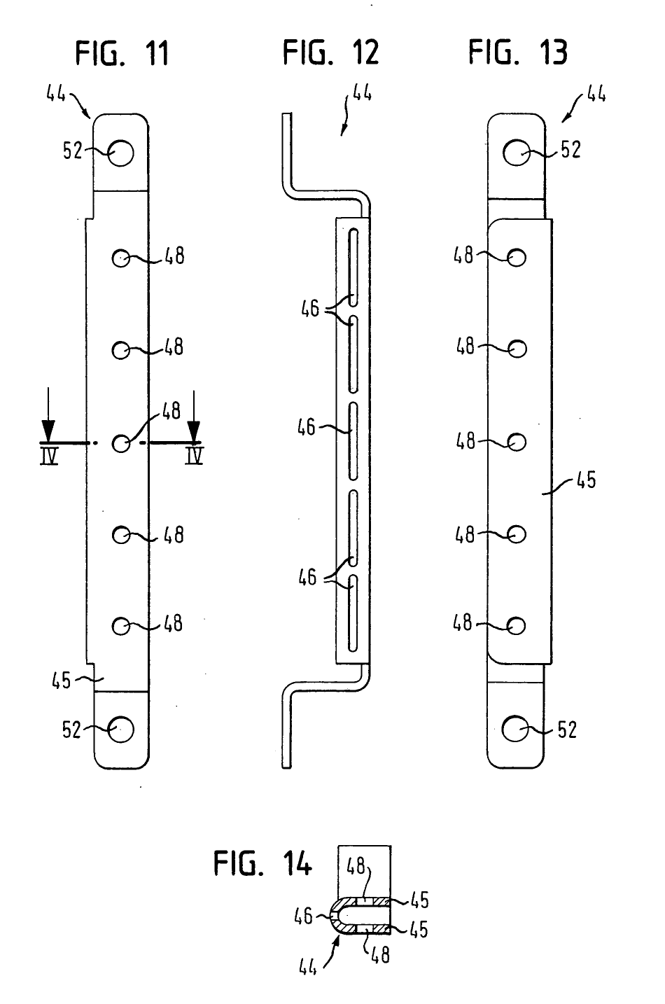

The gas distributor housing 24 is inserted into the mounting opening 22 of the gas bag 12 so that the fastening points 32 in the fastening tongue 30 correspond to the holes 50 in the wall section 42 of the gas bag 12 (FIG. 9). A strip 44 which has a U-shaped cross-sectional profile (FIG. 3) is placed from the exterior onto the fastening tongue 30 and onto the wall section 42 of the gas bag 12 adjoining thereto. The strip 44 is illustrated in detail in FIGS. 11 to 14. The U-shaped strip 44 has two arms 45 lying opposite each other with fastening points 48 arranged congruently in the arms 45. In addition, the strip has slit-shaped perforations 46 in the fold connecting the two arms 45. The perforations 46 facilitate the mounting of the strip 44 on the fastening tongue 30 and the wall section 42 of the gas bag 12. The strip 44 has, in addition, fastening holes 52 by means of which the gas bag module 10 can be securely connected with the vehicle, for example with the back rest of a vehicle seat, which is not illustrated. The fastening holes 52 are arranged here in angled sections which are formed on the ends of the strip 44 and project from one of the arms 45, so that the strip 44 is spaced apart from the supporting part on the vehicle.

The fastening tongue 30 and the wall section 42 of the gas bag 12 are clamped between the free arms 45 of the U-shaped strip 44. As can be seen from FIGS. 9 and 10, through the application of the U-shaped strip onto the fastening tongue 30 and the wall section 42 in the direction of the arrow A, a slack which is present on the gas bag is eliminated and the separating seam 20 is drawn in the direction of the arrow B onto the diffusor section 26 of the gas distributor housing 24. The separating seam 20 therefore, after the installation of the strip 44, lies with its free end or with the reinforcement 40 closely against the diffusor section 26, whereby a gas exchange between the chambers 16 and 18 is efficiently prevented.

The application of the strip 44 onto the fastening tongue 30 and the wall section 42 takes place such that the strip 44 is put in place with opened-out arms 45 in arrow direction A and then the arms are bent up onto the fastening tongue 30 and the wall section 42 of the gas bag 12. The fastening points 48 of the strip 44 correspond to the fastening points 32 in the fastening tongue 30 and the holes 50 in the wall section 42 of the gas bag 12.

As an alternative to the embodiment illustrated here, the strip 44 can also consist of two separate strips which then undertake the function of the arms 45. Also in this embodiment, by the elimination of the slack on the gas bag a tension is exerted onto the separating seam 20, which thereby lies closely against the diffusor section 26 and separates the chambers 16, 18 reliably from each other.

For the installation of the gas bag module 10, firstly the gas generator 14 with the gas distributor housing 24 is introduced into the mounting opening 22 of the gas bag 12 or the chamber 16, so that the fastening tongue 30 of the gas distributor housing 24 adjoins the wall section 42 of the mounting opening 22 or of the gas bag 12. As illustrated in FIG. 2, the mounting opening is constructed to be so great that a comfortable introduction of the gas generator 14 and of the gas distributor housing 24 is possible and the separating seam 20 merely lies loosely against the flattened diffusor section 26 or a play is present between separating seam 20 and diffusor section 26 (FIG. 2).

The slack on the gas bag 12 present after the introduction of the gas generator 14 and of the gas distributor housing 24 into the mounting opening 22 is eliminated in that the U-shaped fastening strip 44 is pushed or bent from the exterior onto the fastening tongue 30 and the wall section 42 of the gas bag 12 adjoining thereto. Through this application of the strip 44, the wall section 42 is pressed closely against the fastening tongue 30 and the adjoining parts of the gas distributor housing 24 and is clamped between the arms 45 of the strip 44. At the same time, through this process, the distance between the separating seam 20 and the diffusor section 26 is shortened and the separating seam 20 is drawn onto the diffusor section 26 so that it lies closely against it (FIG. 3). By means of the fastening points 32 in the fastening tongue 30 and the fastening points 48 in the strip 44, the gas bag 12 is fixed in this position, for example by rivets or screws. The further fastening of the gas bag module 10 on the vehicle can take place by the fastening points 52 provided on the strip 44.

The invention therefore ensures an easier installation, able to be automated, of the gas generator 14 in the gas bag module 10 with, at the same time, a tight separation of the chambers 16, 18 in the gas bag 12.

1. A gas bag module (10) for a safety arrangement in vehicles comprising
a gas bag (12) having at least two chambers (16, 18) separated from each other by a separating seam (20) and a mounting opening (22) formed in one of the chambers (16), and
a gas generator (14) held at least partially in the mounting opening (22) and having a housing (24), wherein the housing comprises a diffusor section (26) associated with the chambers (16, 18) and a fastening section (30, 32) for mounting the gas generator (14) securely with the vehicle,
wherein the fastening section (30, 32) is held inside the mounting opening (22) and adjoins a wall section (42) of the mounting opening (22), and
wherein a fastening means (44) is provided, which fixes the wall section (42) from the exterior of the mounting opening on the fastening section (30, 32) and also acts upon the separating seam (20) with tension and secures it to the diffusor section (26).

2. The gas bag module (10) according to claim 1, characterized in that the gas generator (14) is a tubular gas generator.

3. The gas bag module (10) according to claim 1, characterized in that the gas bag (12) is a two-chambered side gas bag.

4. The gas bag module (10) according to claims 1, characterized in that the diffusor section (26) is adapted for filling the chambers (16, 18) with different internal pressures.

5. The gas bag module (10) according to claim 1, characterized in that the fastening section (30, 32) is arranged opposite the diffusor section (26).

6. The gas bag module according to claim 1, characterized in that the fastening section (30, 32) comprises at least one fastening tongue (30).

7. The gas bag module according to claim 6, characterized in that the fastening tongue (30) projects radially from the housing (24).

8. The gas bag module according to claim 6, characterized in that the fastening tongue extends along the housing (24).

9. The gas bag module according to claim 1, characterized in that the fastening section (30, 32) comprises several fastening points (32) which correspond to fastening points (48; 50) in the fastening means (44) and in the wall section (42).

10. The gas bag module according to claim 1, characterized in that the fastening means (44) comprises two strips lying opposite each other.

11. The gas bag module according to claim 1, characterized in that the fastening means (44) comprises a strip with a U-shaped cross-sectional profile, which embraces the fastening section (30, 32) together with the adjoining wall section (42).

12. The gas bag module according to claim 11, characterized in that the strip (44) has a fold with perforations (46).

13. The gas bag module according to claim 1, characterized in that the fastening means (44) comprises one or more angled sections with fastening points (52) for mounting the gas bag module (10) securely with the vehicle.
